(19) United States
(12) Patent Application Publication
(10) Pub. No.: US 2001/0016836 A1
(43) Pub. Date: Aug. 23, 2001

(54) METHOD AND APPARATUS FOR DISTRIBUTING MULTIMEDIA INFORMATION OVER A NETWORK

(76) Inventors: GILLES BOCCON-GIBOD, MOUNTAIN VIEW, CA (US); GENE COOK, SAN FRANCISCO, CA (US)

Correspondence Address: JAMES H SALTER, BLAKELY SOKOLOFF TAYLOR & ZAFMAN, 12400 WILSHIRE BOULEVARD, SEVENTH FLOOR, LOS ANGELES, CA, 900251026

(21) Appl. No.: 09/184,778

(22) Filed: Nov. 2, 1998

(51) Int. Cl. H04L 9/08; G06F 12/14; H04L 12/22

(52) U.S. Cl. 705/51; 705/71; 380/279; 713/193

(57) ABSTRACT

A system and method of distributing music and video signals over a network is disclosed. In one embodiment a unique encryption key is generated based on who the user is and what content the user is requesting to download. When a user downloads a new music or video title, it is encrypted in a manner which no other users can decrypt. The encryption key needed to encrypt the digital music or video signal is stored on the client in an opaque format to prevent duplication and unauthorized playback. In another embodiment the user belongs to one or more subscription groups receives a subscription-based key. In another embodiment, electronic commerce units will be used to purchase music and video content. Also disclosed is a unique system and method for transferring digital multimedia content to one of a plurality of hardware players. In one embodiment the multimedia content is transferred to the hardware player in encrypted format. The multimedia content is then encrypted in the hardware player using a unique playback encryption key and a decryption module within the hardware player. In another embodiment the multimedia content is decrypted and then only a portion of the signal is re-encrypted before being transferred to the hardware player.

### BACKGROUND OF THE INVENTION

1. Field of the Invention

This invention relates to the transmission of digital multimedia information across a computer network. More particularly, the present invention relates to a method and apparatus by which an end user may purchase and download digital audio and video content in an encrypted format.

2. Description of the Related Art

Compact disks and magnetic tapes represent the two most common formats for distributing recorded music. Similarly, VHS cassettes and, more recently, digital video disks (hereinafter “DVDs”) are two well known formats used to distribute video productions. There are numerous drawbacks associated with each of these music and video formats, however.

Analog storage formats such as magnetic tapes suffer from high distortion and low quality reproduction. Although digital storage formats such as compact disks and DVDs provide for higher quality music and video reproduction, these formats still suffer from the problem of degradation and damage over time. Additionally, to reach the consumer, music stored on these media must move through a relatively inefficient chain of distribution (i.e., manufacturer, retailer, and then end-user). Thus, a more efficient and reliable transfer mechanism for digital music and video is needed.

The distribution of music and video signals over a computer network provides a solution to all of the foregoing problems. As stated above, music and video signals found on compact disks and DVDs are stored in a digital format. This simply means that the underlying analog music and video signals are encoded into a signal comprised of a series of zeros and ones. Accordingly, personal computers which operate in a digital environment provide a natural medium for the retrieval, storage and manipulation of such signals. Up until recently, the mass distribution of music and video via computer networks (e.g., the Internet) was untenable because only a small percentage of consumers owned personal computers and, of the percentage that owned computers, an even smaller percentage were able to access a network. Today, however, personal computers have become pervasive in our society. Moreover, the percentage of computer users who have access to the Internet continues to grow each year at an exponential rate.

Although systems for downloading music and video over the Internet are currently in place, no satisfactory standards have been established. Moreover, because digital information is easily copied with a personal computer, the problem of unlawful duplication of music and video is an issue which has yet to be fully addressed. Thus, what is needed is a system and method for the mass distribution of music and video which will protect the copyright holders of the underlying music and video titles by ensuring that only those consumers who pay for the works have the ability to reproduce them. Accordingly, it is an objective of this invention to provide an improved encryption and playback system for music and video content downloaded off of a network. It is a further objective of this invention to establish an improved payment system for music and video purchases over a network.

### SUMMARY OF THE INVENTION

The present invention relates to a system and method of distributing music and video signals over a network. When a user installs helper software on a client (e.g., a personal computer) a unique communication encryption key and a unique user ID are also installed. The communication encryption key is stored in an opaque format to prevent duplication. When the client initially connects to the server, the server identifies the client based on the unique user ID. Using this information, the server identifies the correct communication encryption key to use to open a secure communication channel with the client.

In one embodiment a unique encryption key is generated based on who the user is and what content the user is requesting to download. Thus, every time a user downloads a new music or video title, it is encrypted in a manner which no other users can decrypt. The encryption key needed to encrypt the digital music or video signal is stored on the client in an opaque format to prevent duplication and unauthorized playback.

In another embodiment the user belongs to one or more subscription groups. Once signed up with a particular subscription group, the user will receive a subscription-based key. When the user attempts to download a music or video title which is categorized under a subscription to which the user belongs, the title will be encrypted using the subscription-based key.

In another embodiment electronic commerce units are used to purchase music and video content. The server will check its database to determine whether the user has sufficient electronic commerce units to download the requested music or video content. When the user initially establishes an account he may be assigned an electronic commerce card which provides him a set number of electronic commerce units. Alternatively, the user may be assigned an electronic commerce card with a predetermined number of electronic commerce units before the user establishes an account on server. The user can then acquire additional electronic commerce units through, for example, music company promotions, or he can purchase additional units.

Also disclosed in one embodiment is a unique system and method for transferring digital multimedia content to one of a plurality of hardware players. In one embodiment the multimedia content is transferred to the hardware player in encrypted format. The multimedia content is then encrypted in the hardware player using a unique playback encryption key and a decryption module within the hardware player. In another embodiment the multimedia content is decrypted and then only a portion of the signal is re-encrypted before being transferred to the hardware player.

### BRIEF DESCRIPTION OF THE DRAWINGS

A better understanding of the present invention can be obtained from the following detailed description in conjunction with the following drawings, in which:

FIG. 1 illustrates generally an embodiment of the recited claims including a data network through which a client and server communicate.

FIG. 2 illustrates an embodiment of the server of FIG. 1 in greater detail.

FIG. 3 illustrates an embodiment of the client of FIG. 1 in greater detail.

FIG. 4 is a flow diagram illustrating an initial setup procedure.

FIG. 5 is a flow diagram which sets forth a file request and download procedure.

FIG. 6 is a flow diagram which sets forth a playback procedure.

FIG. 7 is table illustrating encryption key generation generally.

FIG. 8 is a table illustrating mass-distribution and subscription-based encryption key generation.

### DETAILED DESCRIPTION OF THE PREFERRED EMBODIMENT

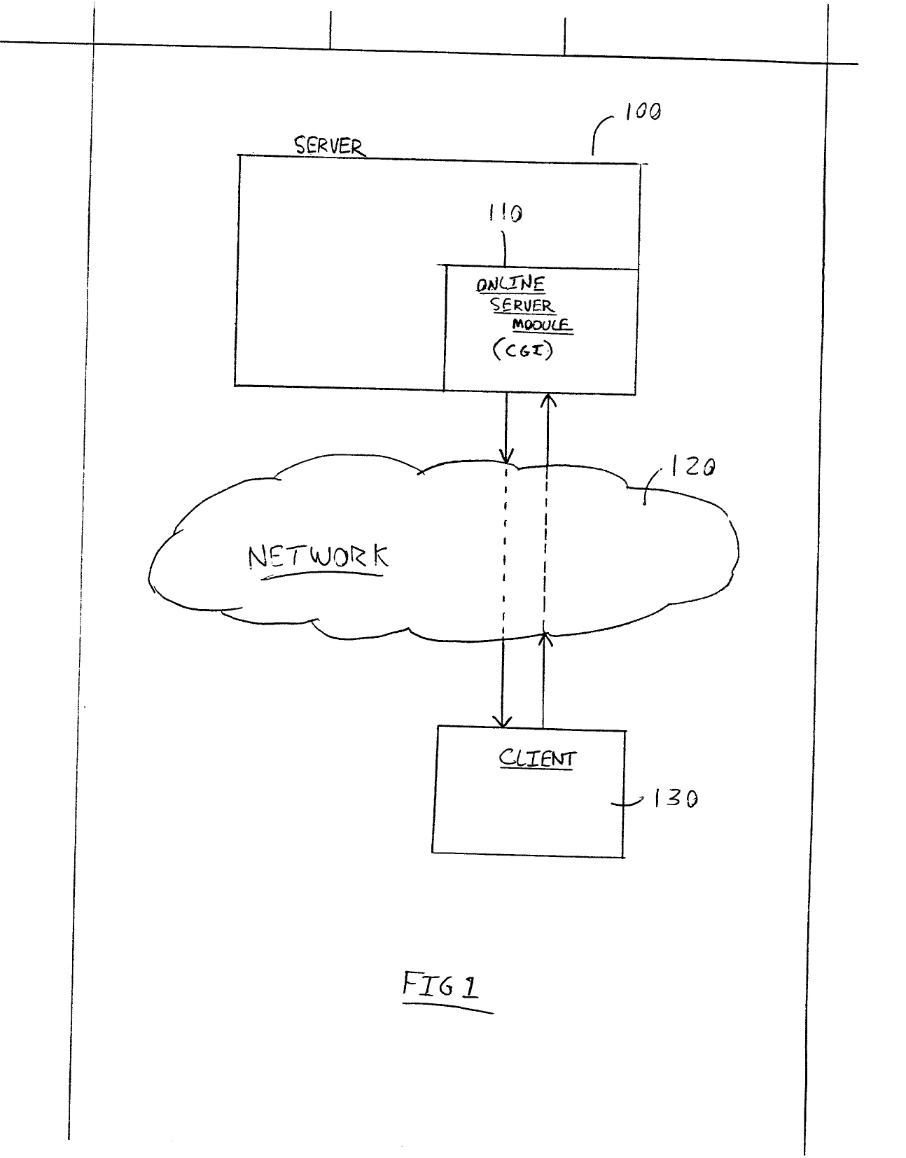

FIG. 1 generally depicts an embodiment the present system and method for distributing music and video (i.e., multimedia) information. One or more clients 130 connect to a server 100 over a data network 120. The client 130 may be a consumer running a personal computer and connecting to server 100 via the Internet 120. The server in one embodiment is a computer system upon which an online server module 110, generally a common gateway interface program (hereinafter “CGI”), is executed to communicate with client 130. In a preferred embodiment of the recited system, both the server 100 and the client 130 are networked computers each comprising a processor and a memory with which software implementing the network functionality of the present invention is executed. This functionality is described below.

One of ordinary skill in the art will readily recognize from the following discussion that, depending on the system configuration, different types of servers, clients and software could be employed without departing from the underlying principles of the present invention. Moreover, while the embodiment discussed below uses an Internet connection for communication between client 130 and server 100, other communication schemes such as a direct connection to server 100, etc., could be implemented as well.

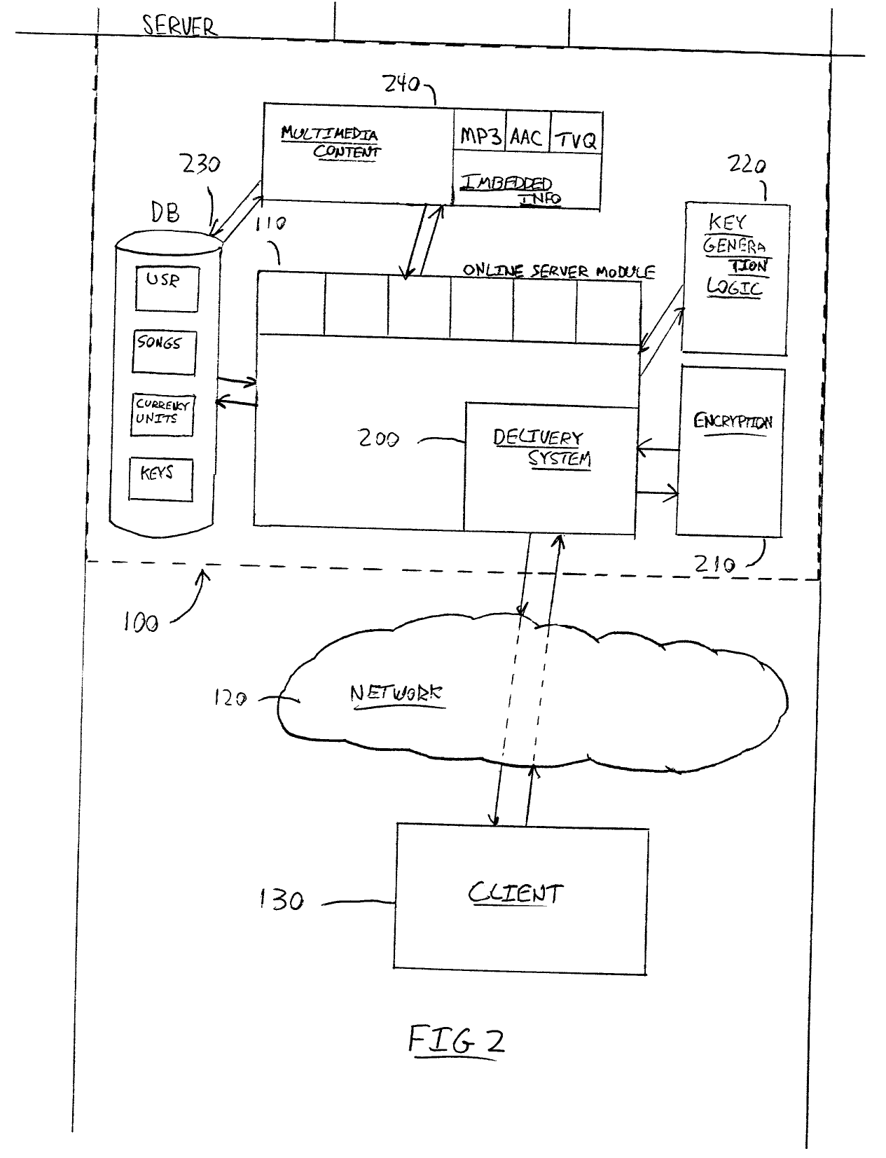

FIG. 2 illustrates server 100 in greater detail. Online server module 110 of server 100 communicates to client 130 via delivery system 200. Included in sever 100 is an encryption module 210 for encrypting communication between client 130 and server 100. Additionally, server 100 includes key generation logic 220 for generating keys used by online server module 110 and client 130 as described herein. Server 100 also includes a database unit, typically residing on one or more hard disk drives. In one embodiment database 230 is a relational database used to store information used by online server module 110 to store music and video content as well as information about client 130. As described below, music and video content are stored in database 230 in a unique file format 240. In one embodiment a single digital music file will contain additional information related to the musical composition. For example, the lyrics of the song, the underlying musical score, pictures, video and other information about the orchestra or band (e.g., upcoming tour dates) will be imbedded into the digital file format. Additionally, when a user downloads multimedia content from server 100 as described below an identification number associated with the purchaser will be appended to the file format 240. This number will be used to identify the owner of the multimedia content.

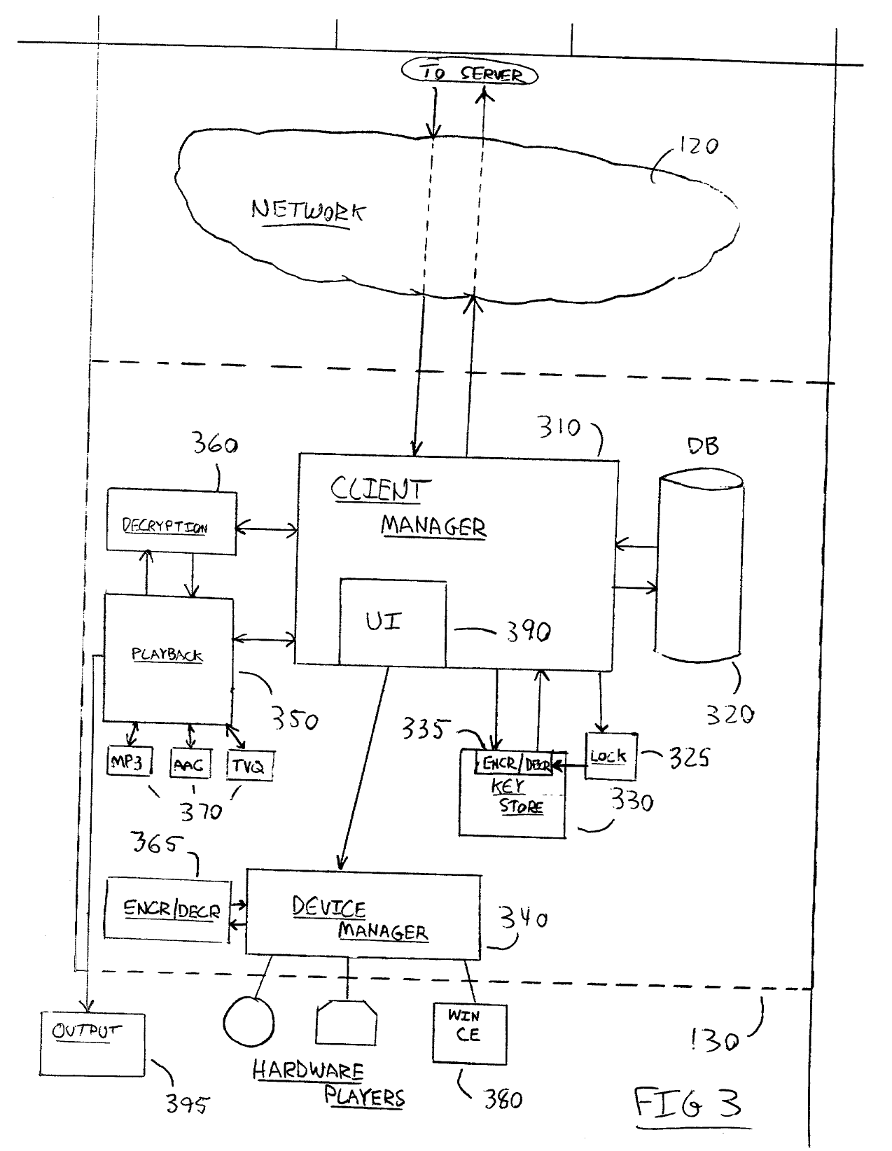

FIG. 3 illustrates client 130 in greater detail. Client helper software installed on client 130 includes client manager module 310, playback module 350, codec units 370, encryption/decryption modules 360 and 365, key store 330, key store lock 325 and device manager 340. Client 130 communicates to server 100 via client manager 310. Client also includes a database 320 for storing music and video content previously downloaded from server 100 as well as configuration information for client manager 310. Playback module 350 is used by client manager 310 to reproduce music and video content downloaded from server 100. Playback module 350 operates (as described in more detail below) in conjunction with decryption module 360 to decrypt content encrypted by server 100. Key store 330 includes encryption keys needed by playback module 350 and decryption module 360 in the decryption process. Key store 330 is hidden on client 130 in an opaque digital format as described below to prevent the copying of user keys from key store 330. This reduces the possibility of unlawful reproduction of music and video content by an unregistered user. In other words, if the key store 330 was easily accessible, a user could simply copy keys from key store 330 (e.g., to a floppy disk) and thereby allow other users access to the decrypted music and video content.

Playback module 350 communicates with codec units 370 to decompress music and video content before playback. In an alternative embodiment codec units 370 are incorporated within playback module 350. As is well known in the art, the use of compression algorithms to compress digital audio and video signals significantly decreases the storage space required to store such signals. For example, using the well known MP3 compression standard for audio signals, a compression ratio of 12:1 can be achieved with virtually no loss in sound quality. Thus, when a 5 megabyte digital music file is compressed using Motion Picture Experts Group Standard, 3rd version (MPEG-3 or MP3) it will take up less than ½ megabytes of hard drive space. This is significant not only in terms of saving hard drive space but also in terms of the time required for client 130 to download music and video content. This is particularly true if client 130 is connecting to server 100 over a typical dial-up modem connection through network 120 (over which the fastest speed possible is approximately 53,000 bits/second). Another compression standard known in the art is “Advanced Audio Coding” (ACC). In a preferred embodiment client manager software 310 will be upgradeable so that when new compression standards are established in the industry, users registered on server 100 will automatically receive an update of their helper software on client 130 which includes the new decompression codec units 370.

Output module 395 receives the decompressed and decrypted music or video signal (possibly in analog format) and completes the reproduction of the signal. Thus, in the case of music content, output module 395 might simply consist of a speaker system. In the case of video reproduction, output module 395 might consist of a video monitor and a speaker system.

Device manager 340 communicates to client manager 310 through user interface 390. In one embodiment device manager 340 receives music content from client manager 310 in encrypted format and transfers the encrypted content to a memory (e.g., flash memory) within one or more portable music players 380. An example of such a portable music player is the Rio pmp300 from Diamond Multimedia Systems, Inc. In another embodiment the portable music player is a device running the Windows CE® operating system configured to decrypt and decompress the multimedia content. Windows CE® is developed by Microsoft Corp., Redmond, Wash.

Transferring the digital music signal in encrypted format prevents unlawful duplication of the music content by users who do not have a right to reproduce (i.e., have not purchased) the content. Thus, in order to decrypt the encrypted music format, in one embodiment of the recited claims, portable music players 380 contain a subset of client helper software described herein including a playback module 350, codec units 320, a decryption module 360 and a key store 330.

In another embodiment client manager 310 sends the digital music signal to device manager 340 after decrypting the signal using decryption module 360. Device manager 340 then re-encrypts the signal using encryption module 365. Because hardware players currently do not have the same level of processing power as a typical client 130 (e.g., a personal computer with a 400 MHz Pentium processor) it may be beneficial to use a less processor-intensive encryption algorithm. For example, instead of encrypting the entire underlying signal, device manager 340 may use encryption module 365 to encrypt every 10^{th} byte of the signal. Accordingly, the playback encryption key for the music content stored in key store 330 can be used by encryption module 365, but only a portion of the underlying signal will be encrypted. In one embodiment, encryption module 360 and encryption module 365 are the same module (but used in a different manner by playback module 350 and device manager 340.

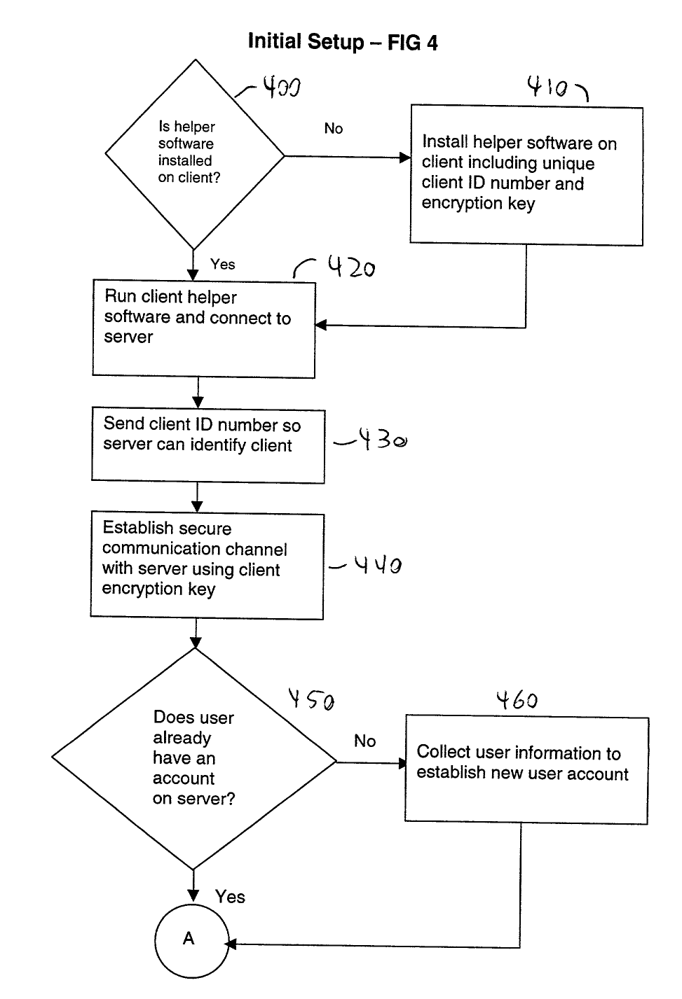

Referring now to FIGS. 4, 5, and 6, the operation of the present invention will be described in greater detail. FIG. 4 is a flow chart illustrating the initial setup procedure of helper software on client 130. In a preferred embodiment, a potential user will download a copy of the helper software used on client 130 from the server 100 over network 120, or possibly from a different server (e.g., a world-wide-web server). Alternatively, user can call and request a copy of the helper installation software on compact disk, floppy disk, or DVD format.

If helper software is already installed on client 130 (step 400) the next step will be to run the software and connect to server 100 (step 420). However, if the helper software is not yet installed, it will be installed on client 130 at step 410. When helper software is installed at step 410, a unique client ID number and communication encryption key are assigned to client 130.

Once helper software has been installed on client 130 and client 130 has established communication with server 100 (step 420), client manager 310 sends the client ID number to online server module 110 which online server module 110 uses to identify client 130. Once online server module 110 identifies client 130 using the unique ID number, online server module 110 is then able to automatically identify the communication encryption key that it needs to use to establish a secure communication channel with client 130. It is important to establish a secure communication channel between client 130 and server 100 across network 120 because network 120 is generally an unsecure environment. That is, confidential communications and other transmissions (e.g., credit card numbers) can be intercepted by other clients on network 120. Thus, by using a communication encryption key to encrypt communications, if the encrypted data is received by other users on network 120 they will not be able to decrypt it without the encryption key. For this reason, in the present embodiment online server module 110 identifies the correct communication encryption key using the client ID number, rather than sending a communication encryption key across the network 120. That is, if server 100 was required to communicate an encryption key over network 120 to establish a secure communication channel with client 130, other users could intercept the communication encryption key and use it to decrypt the confidential communications between server 100 and client 130.

Once a secure communication channel has been established at step 440, the next step is to determine whether the user connecting from client 130 is already set up with an account on server 100. For example, a particular user could have initially established an account from an office computer and could now be attempting to connect to server 100 from a home computer. If the user has not established an account on server 100, the user will be prompted to submit information in order to establish an account (e.g., name, address, telephone number, billing information, etc.). Once the user has input the required account information, online server module 110 creates a user data object to be stored in database 230 which contains information about the user. The user data object includes a client manager ID as well as a user ID. Online server module 110 uses the client manager ID to identify which client 130 the user is connecting from (assuming that the user connects from more than one client). The user data object also includes the user's login name and password.

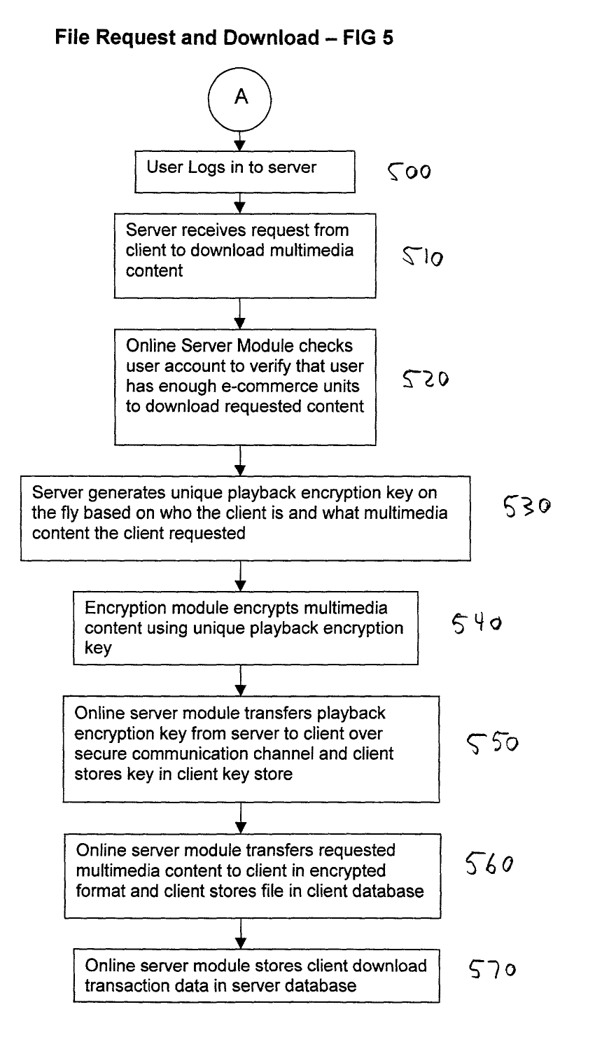

Referring now to FIG. 5, once an account has been established on server 100, the next time the user attempts to connect to server 100 from client 130, he will be prompted to log in using his login name and password (step 500). Once logged in, the user can then browse through a directory of audio and video content. A user may also sign up for a particular subscription group. For example, in one embodiment when the user initially signs up he will be asked about the type of music which he prefers. He will then be added to a subscription group comprised of songs which fall under that particular musical category (e.g., Jazz, Classical, Alternative, etc.). Then, when the user logs on he will be shown primarily subscription-based musical content.

When the user decides to purchase a particular song or video, client manager 310 will send a request to online server module 110 of server 100 (step 510). Online server module 110 will then check database 230 to determine whether the user has sufficient electronic commerce units, known in the present system as “Mjuice™” units, to download the requested music or video content. Mjuice™ units can be acquired in a number of ways. For example, when the user initially establishes an account on server 100 he may be assigned an Mjuice™ card which provides him an initial number of Mjuice™ units. Alternatively, the user may be assigned an Mjuice™ card with a predetermined number of Mjuice™ units before the user establishes an account on server 100. Server 100 would identify the card based on an Mjuice™ card identification number hard-coded on the card. Once the user has established an account, he will instantly have a predetermined amount of Mjuice™ credit towards purchasing music and video content on server 100.

The user can then acquire additional Mjuice™ units through, for example, music company promotions, or he can purchase additional units over network 120. In one embodiment the payment for Mjuice™ units is separate from the selection and download of music content. That is, if a user required additional Mjuice™ units to purchase multimedia content, he will be redirected to an e-commerce server where he can use his credit card to pay for additional units. The e-commerce server will then communicate with server 100 and server 100 will update the user's account with the additional Mjuice™ units.

Once online server module 110 determines that the user has sufficient Mjuice™ units to download the requested content, online server module 110 communicates with key generation logic 220 to generate a unique playback encryption key for the requested content based on who the user is and the content requested by the user. In an alternative embodiment key generation logic 220 is incorporated within online server module 110. It should be noted that the playback encryption key generated at step 530 is different from the communication encryption key generated at step 440 of FIG. 4. The communication encryption key at step 440 is used to encrypt all communications between online server module 110 and client manager 310 to establish a secure communication channel. By contrast, the playback encryption key generated at step 530 is used by encryption module 210 to encrypt specific music and video content (step 540) which will be subsequently downloaded and stored on client database 320 so that the user can play back the content at a later time.

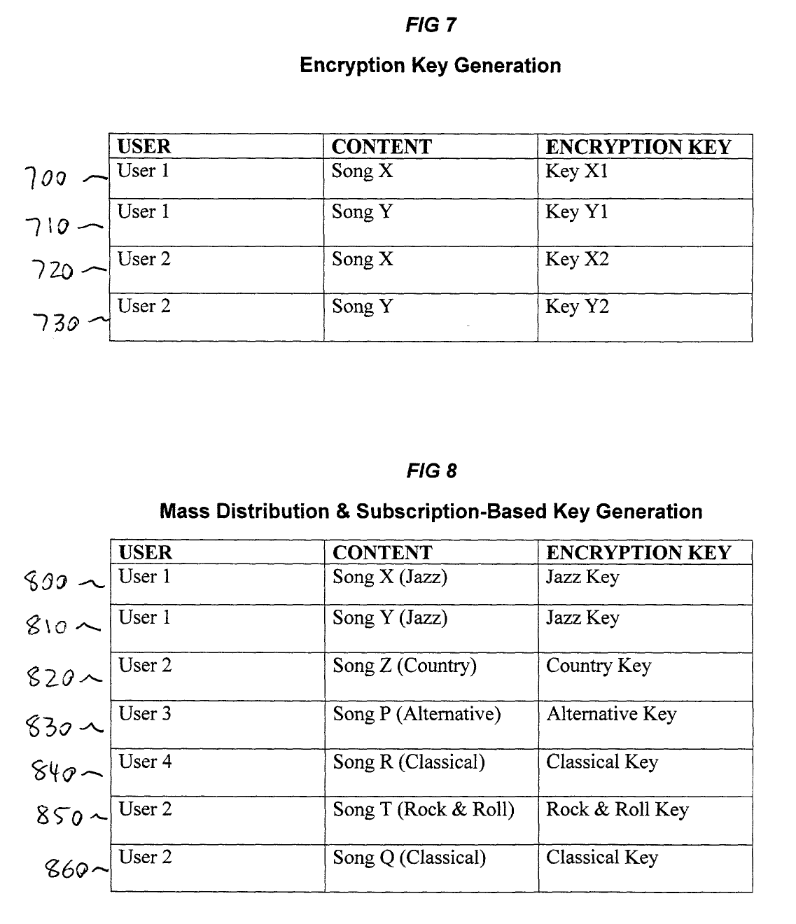

FIG. 7 is a table which will help illustrate the operation of key generation logic 220. As shown in the table at row 700, if User 1 requests Song X (and if Song X is not categorized under a subscription group to which User 1 belongs as described below), key generation logic 220 will generate a unique playback encryption key X1 based on Song X and User 1. This will be the only key that can be used to play back this encrypted version of Song X. If User 2 requests Song X, key generation logic 220 will generate a different playback encryption key (key X2). Similarly, if User 1 requests Song Y, key generation logic will generate playback encryption key Y1.

At step 550, delivery system 200 of online server module 110 will transfer the playback encryption key X1 to client manager 310 over the secure communication channel. Client manager 310 will then store playback encryption key X1 in key store 330. As described above, key store 330 will store the playback encryption key in an opaque format so that it cannot easily be extracted from key store. This will prevent unlawful duplication of playback encryption key X1 and encrypted Song 1 by a potential copyright infringer.

As shown in FIG. 3, in one embodiment of the recited claims key store 330 is hidden using a key store encryption module 335. Each installation of client helper software includes a unique key store lock 325 used to encrypt and decrypt the keys stored in key store 330. In other words, the key store, which contains unique playback encryption keys, is itself encrypted to prevent unlawful duplication of the playback encryption keys, using a unique key store lock 325. The additional encryption step is implemented as a supplementary defense against unlawful reproduction of the underlying multimedia works.

At step 560 online server module transfers the encrypted multimedia content (e.g., encrypted Song 1) to client manager 310 and client manager 310 stores the content in database 320. It should be noted that steps 550 and 560 can take place in reverse order. That is, the delivery system 200 of online server module 110 could transmit the requested multimedia content to client manager 310 before transmitting the encryption key.

At step 570, online server module 110 stores User 1's download transaction (i.e., the download of Song X) in server database 230. This includes storage of the unique playback encryption key generated at step 530. In this way, server 100 keep track of all of User 1's transactions and all of User 1's encryption keys. Accordingly, if User 1 loses any or all of his downloaded music or video content (e.g., through failure of database 320 on client 130) he can simply request to re-download all of the content from server database 230. This enables a user of client 130 to develop and extensive music and video database without the need to continual backups of client database 320.

Referring now to FIG. 8, in another embodiment the same encryption key can be used by different users. For example, if User 1 signed up on server 100 with a “Jazz” subscription group, and if Song X was a jazz title, then (at step 530) the encryption key generated by key generation logic 220 would be a subscription-based Jazz encryption key. In one embodiment of the recited claims subscription-based keys, once generated, are stored in database 230 for later use by other members of the subscription group.

Thus, as shown in rows 800 and 810 of FIG. 8, both User 1 and User 2 would download the same encryption key for playback of Song X and Song Y, respectively. Similarly, referring to rows 840 and 860, if User 4 and User 2 were registered on server 100 as part of a “Classical” subscription group, and if Songs R and Q were classical titles, then both songs would be encrypted (by online server module 110 and encryption module 210) using the same “Classical” encryption key. If User 4 did not belong to a classical subscription group, however, and still requested to download Song R (as shown in row 840), then a unique encryption key—e.g., Key R4—would be generated by key generation logic 220. Accordingly, a flexible method and system is disclosed for transmitting music and video content while still protecting the rights of the copyright holders.

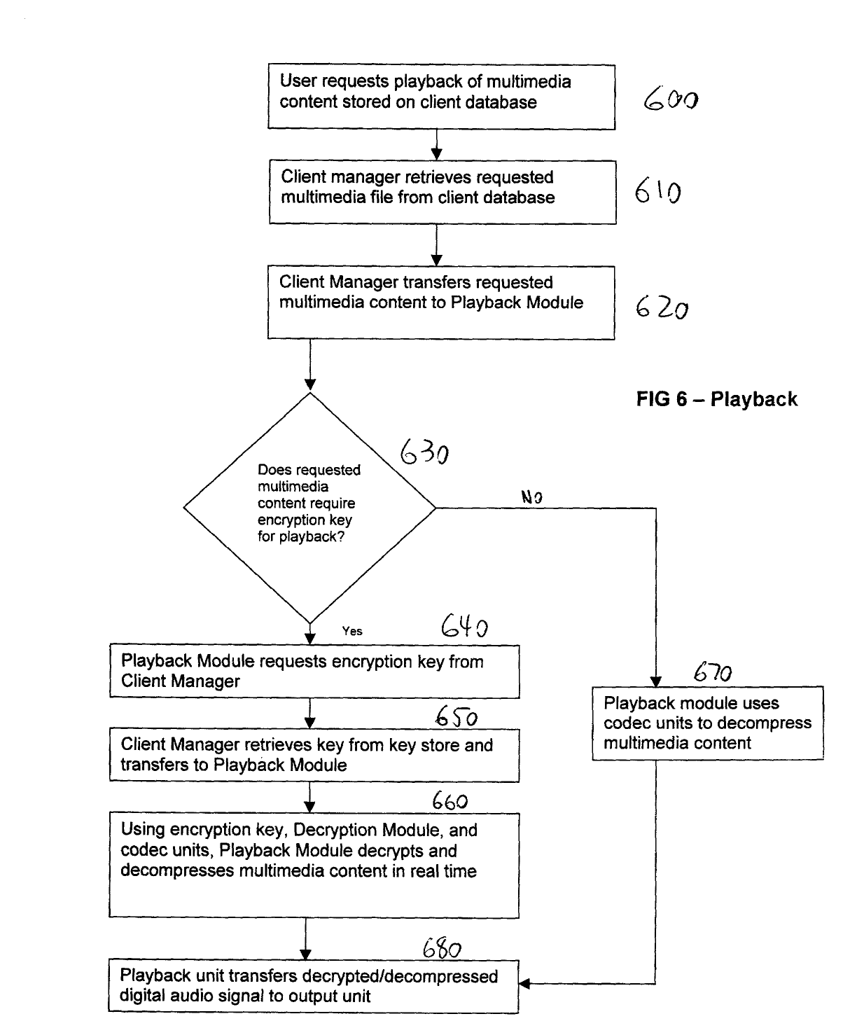

Referring now to FIG. 6, the playback of multimedia content by client 130 will be described. At step 600 a user initially requests playback of music or video content stored in client 130. Next, at step 610, client manager 310 retrieves the requested content from database 320 and, at step 620, transfers the requested content to playback module 350 for playback. At step 630 playback module determines whether the requested multimedia content requires an encryption key for playback. Under some circumstances no decryption of a video or music title may be required. For example, for works which are no longer protected by copyright (e.g., if the copyright has expired) there is no reason to require encryption. In one embodiment the playback module examines the data header of the requested music file to determine whether encryption is required. If compression is not required, then at step 670 playback module uses codec units 370 to decompress the multimedia content in real time.

If decryption is required, however, then playback module 350 requests the necessary encryption key from client manager 310 at step 640. In one embodiment playback module determines which key is required based on a key identification code located in the data header of the requested music or video file. At step 650, client manager retrieves the necessary encryption key from key store 650 and transfers the key to playback module 350.

Playback module then uses the encryption key, decryption module 360 and codec units 370 to decrypt and decompress the multimedia content in real time at step 660. To accomplish the decryption/decompression process in real time, playback module sends portions (e.g., 64-bytes) of the encrypted/compressed multimedia content through decryption module which uses the playback encryption key to decrypt the portions of multimedia content. Then playback module 350 sends the decrypted portions of the multimedia content through codec units 370 where the decrypted portions of multimedia content are decompressed. As stated above, using compression algorithms to compress and decompress digital music or video content is well know in the art. Thus, playback module is able to reconstruct the underlying multimedia signal in real time by decrypting and decompressing the multimedia content piece by piece, instead of first decrypting and then decompressing the entire underlying signal.

Finally, after the music or video content has been decrypted and decompressed, playback unit 350 sends the decrypted/decompressed digital signal to output unit 395 (step 680). In one embodiment output unit includes an A/D converter to convert the digital signal to analog and also includes components necessary to reproduce the underlying analog signal. For example, if the underlying signal is music, then a speaker system is used to reproduce the signal; if the underlying signal is video, then a video monitor is used. The concepts of A/D conversion and reproduction of the underlying analog signal are well known to those of skill in the art.

What is claimed is:

1. A method for distributing multimedia content from a server to a client over a network comprising the steps of:
generating a playback encryption key to encrypt the multimedia content, the playback encryption key generated based on the identity of the client and the multimedia content requested by the client;
encrypting the multimedia content at the server using the playback encryption key; and
sending the encrypted multimedia content from the server to the client.

2. The method for distributing multimedia content from a server to a client over a network as claimed in claim 1 including the initial step of establishing a secure communication channel between the client and the server using a communication encryption key.

3. The method for distributing multimedia content from a server to a client over a network as claimed in claim 2 wherein the secure communication channel is established without the server or client sending the communication encryption key across the network.

4. The method for distributing multimedia content from a server to a client over a network as claimed in claim 1 wherein the playback encryption key is generated based on a subscription group to which the client belongs.

5. The method for distributing multimedia content from a server to a client over a network as claimed in claim 1 wherein the server distributes the multimedia content to the client only if the client has sufficient electronic commerce units stored on server.

6. The method for distributing multimedia content from a server to a client over a network as claimed in claim 1 wherein communication between the client and the server is accomplished through a common gateway interface module (“CGI”) executed on the server.

7. The method for distributing multimedia content from a server to a client over a network as claimed in claim 1 wherein the multimedia content is music content.

8. The method for distributing multimedia content from a server to a client over a network as claimed in claim 7 wherein the music content includes additional information about the composer of the music.

9. The method for distributing multimedia content from a server to a client over a network as claimed in claim 1 wherein the multimedia content is compressed using a compression codec.

10. The method for distributing multimedia content from a server to a client over a network as claimed in claim 9 wherein the compression codec used to compress the multimedia content is the MP3 compression codec.

11. The method for distributing multimedia content from a server to a client over a network as claimed in claim 2 where the server periodically generates a new communication encryption key.

12. The method for distributing multimedia content from a server to a client over a network as claimed in claim 1 wherein the playback encryption key is stored on the client in an opaque format.

13. The method for distributing multimedia content from a server to a client over a network as claimed in claim 7 including the additional step of transferring the multimedia content from the client to a portable music player.

14. The method for distributing multimedia content from a server to a client over a network as claimed in claim 13 wherein the multimedia content is transferred to the hardware music player in an encrypted format.

15. The method for distributing multimedia content from a server to a client over a network as claimed in claim 1 wherein the server stores all of the multi media content downloaded by the client and of all encryption keys needed by the client to decrypt the multimedia content.

16. The method for distributing multimedia content from a server to a client over a network as claimed in claim 15 including the step of the server transferring all previously downloaded multimedia content to the client.

17. The method for distributing multimedia content from a server to a client over a network as claimed in claim 1 including the step of the server determining whether the client has sufficient electronic commerce units to download the requested multimedia content.

18. The method for distributing multimedia content from a server to a client over a network as claimed in claim 17 wherein the electronic commerce units are assigned to client before client establishes an account on the server by way of a pre-paid music card.

19. The method for distributing multimedia content from a server to a client over a network as claimed in claim 18 wherein the client communicates an identification number printed on the pre-paid music card to server to identify the pre-paid music card being used.

20. A method for distributing multimedia content from a server to a client over a network comprising the steps of:
receiving multimedia content from a server, the multimedia content encrypted using a unique playback encryption key generated based on the identity of the client and the multimedia content;
storing the playback encryption key in a key store; and
decrypting the multimedia content using the playback encryption key.

21. The method for distributing multimedia content as claimed in claim 20 wherein the key store is encrypted to prevent duplication of the playback encryption keys stored therein.

22. The method as claimed in claim 20 including the step of decompressing the multimedia content.

23. The method as claimed in claim 20 wherein the multimedia content received from the server is received over a secure communication channel using a communication encryption key.

24. The method as claimed in claim 23 wherein the secure communication channel is established without the server or client sending the communication encryption key across the network.

25. The method as claimed in claim 24 wherein the server identifies the communication encryption key based on a client identification number

26. The method as claimed in claim 20 wherein the encrypted signal and the playback encryption key are transmitted to one of a plurality of hardware music players.

27. The method as claimed in claim 20 including the additional steps of:
re-encrypting the decrypted multimedia signal using the playback encryption key; and
transmitting the re-encrypted multimedia signal and the playback encryption key to one of a plurality of hardware music players.

28. The method as claimed in claim 27 wherein only a portion of the multimedia signal is re-encrypted.

29. A server having a processor and a memory coupled to the processor, the memory having stored therein sequences of instructions which, when executed by the processor, cause the processor to perform the steps of:
generating a playback encryption key to encrypt multimedia content, the playback encryption key generated based on the identity of a client and the multimedia content requested by the client;
encrypting the multimedia content at the server using the playback encryption key; and
sending the encrypted multimedia content from the server to the client.

30. The server as claimed in claim 29 wherein the server initially establishes a secure communication channel with the client using a communication encryption key.

31. The server as claimed in claim 30 wherein the secure communication channel is established without the server or client sending the communication encryption key across the network.

32. The server as claimed in claim 29 wherein the server distributes the multimedia content to the client only if the client has sufficient electronic commerce units recorded on the server.

33. The server as claimed in claim 29 wherein the multimedia content is compressed using a compression codec.

34. A computer data signal embodied in a carrier wave for distributing multimedia content from a server to a client over a network comprising:
a first source code segment for generating a playback encryption key to encrypt the multimedia content, the playback encryption key generated based on the identity of the client and the multimedia content requested by the client;
a second source code segment for encrypting the multimedia content at the server using the playback encryption key; and
a third source code segment for sending the encrypted multimedia content from the server to the client.
